(19) United States
(12) Patent Application Publication
(10) Pub. No.: US 2017/0278440 A1
(43) Pub. Date: Sep. 28, 2017

(54) Cyclic Redundancy Check For Electronic Displays

(71) Applicant: Manufacturing Resources International, Inc., Alpharetta, GA (US)

(72) Inventors: William DUNN, Alpharetta, GA (US); Scott Hamilton, Coleshill (GB); David Williams, Canton, GA (US); Gerald Fraschilla, Snellville, GA (US)

(21) Appl. No.: 15/077,416

(22) Filed: Mar. 22, 2016

(51) Int. Cl. G09G 3/00

(52) U.S. Cl. CPC G09G 3/006

(57) ABSTRACT

A system and method for preventing image retention in an electronic display. A time threshold (TT) and a pixel threshold (PT) may be defined. The system preferably performs a checksum calculation of all pixel data within an active image area of the electronic display for an interval of time until reaching TT. The system may then compare the checksum calculation for each interval of time to determine if the change in pixel data is less than PT. Preferably, the system will perform an image retention prevention method for the active image area if the change in pixel data is less than PT. Generally, this is performed by transmitting alternate pixel data to the electronic display.

### cross-reference to related applications

This application does not claim priority to any pending applications.

### TECHNICAL FIELD

Embodiments generally relate to electronic displays used for advertising, informational, and point of sale applications.

### BACKGROUND OF THE ART

Electronic displays are now used in a variety of applications where the displays remain on for extended periods of time. In some applications, the displays may show a single static image for hours at a time. In other applications, portions of the display might be showing dynamic video while other portions show a static image. In other applications, a display might malfunction and ‘freeze’ and show a single image until the malfunction has been corrected. It has been found that leaving a static image on an electronic display for a long period of time can cause burn-in or image retention, where distinct marks or patterns can be seen on the display at all times, due to previous long-held static image signals.

### SUMMARY OF THE EXEMPLARY EMBODIMENTS

Exemplary embodiments provide a system and method for determining when image retention could be a concern for an electronic display. The exemplary systems and methods can determine when portions of the display might be at risk, even while others are clearly not. An Image Retention Prevention Method is preferably ran when portions of a display (or the entire display) have been determined to have image retention concerns. The overall appearance of the display should not be affected when the Image Retention Prevention Method is performed. In other words, to a viewer, there should be no discernable difference in the viewed image whether the Image Retention Prevention Method is being ran or not.

The foregoing and other features and advantages of the present invention will be apparent from the following more detailed description of the particular embodiments, as illustrated in the accompanying drawings.

### BRIEF DESCRIPTION OF THE DRAWINGS

A better understanding of an exemplary embodiment will be obtained from a reading of the following detailed description and the accompanying drawings wherein identical reference characters refer to identical parts and in which:

FIG. 1 is a front elevation view of an exemplary electronic display having both dynamic and static images being shown simultaneously, and indicating the location for Detail A.

FIG. 2 is a detailed view of Detail A from FIG. 1, indicating an exemplary embodiment for the Analysis Area as it travels through each Location(L) on the electronic display.

FIG. 3 is a sample chart of exemplary check sum data for each Location(L) at each Time Interval(t).

FIG. 4 is a logical flow chart for operating an exemplary form of the method.

FIGS. 5A and 5B are front elevation views of a selection of pixels, where an embodiment of the Image Retention Prevention Method is being performed.

FIG. 6 is a logical flow chart for a simplified embodiment where the entire active image display area is used as the Analysis Area.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

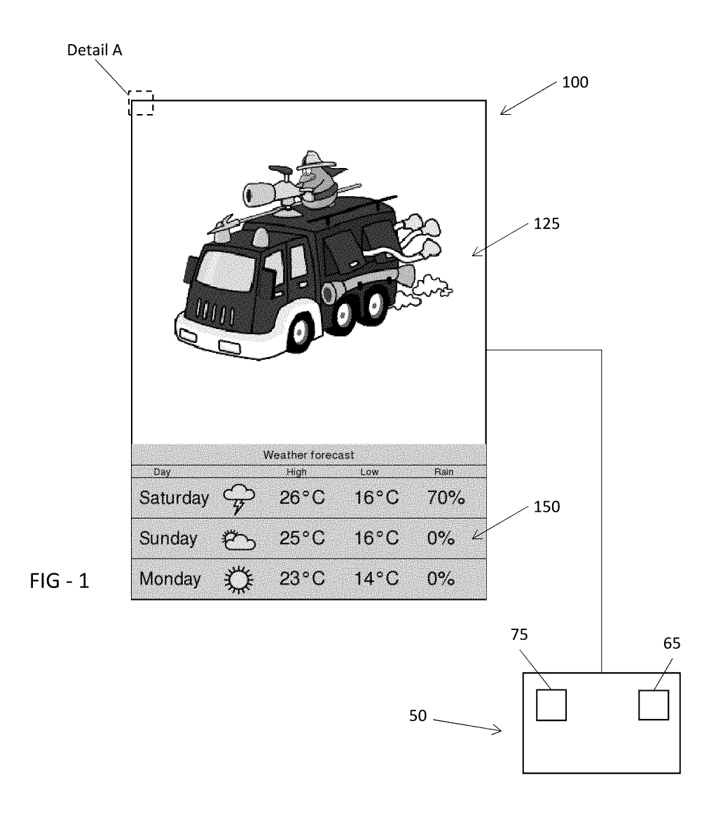

FIG. 1 is a front elevation view of an exemplary electronic display 100 having both dynamic and static images being shown simultaneously, and indicating the location for Detail A. A display controller 50 is in electrical connection with the display 100 and includes several components, specifically a processor 75 and electronic storage 65. As is well known in the art, a display controller 50 can include many different components, which will not be examined in detail here. Generally speaking, a display controller 50 may also be considered a video player, as it may accept the image/video content data for optional modification/analysis (as described herein) and eventual transmission to the display 100. Thus, connections such as incoming power and video signal have not been shown, but would be understood to be present by a person of ordinary skill in the art.

As shown in this figure, the display controller 50 is currently sending pixel data for a dynamic video on a first portion 125 of the electronic display's active image area while simultaneously sending pixel data for a static image on a second portion 150 of the electronic display's active image area. It should be immediately noted, that although a portrait display is shown here, this is not required as any orientation will work with the disclosed embodiments. Further, embodiments are not limited to only two areas (i.e. one dynamic video and one static image) as any number of areas could be combined and there could be multiple static image areas as well as multiple dynamic video areas.

As will be described further below, the exemplary method analyzes the data for pixels of the electronic display, and these pixels can be sub-pixels (a single color) or the combined color pixel (multiple sub-pixels combined to produce a color). There is no requirement for any embodiments that a specific type of pixel is used for the analysis. Further, there is no requirement that a specific type of electronic display is used either, as any display which produces an image based on a combination of pixels will suffice. Thus, the electronic display 100 could be any one of the following: LCD, LED, plasma, OLED, and any form of electroluminescent polymer.

Generally speaking, when presented with the situation shown in FIG. 1, the first portion 125 of the display is generally not susceptible to image retention, since the pixels are changing on a regular basis. However, the second portion 150 of the display is likely susceptible to image retention, since the pixels maintain the same light output (which generally translates to potential difference or voltage applied to each subpixel) for a long period of time. The exemplary method and system herein can detect pixels which have not changed substantially within a chosen Time Threshold (TT), and perform an Image Retention Prevention Method to combat possible image retention.

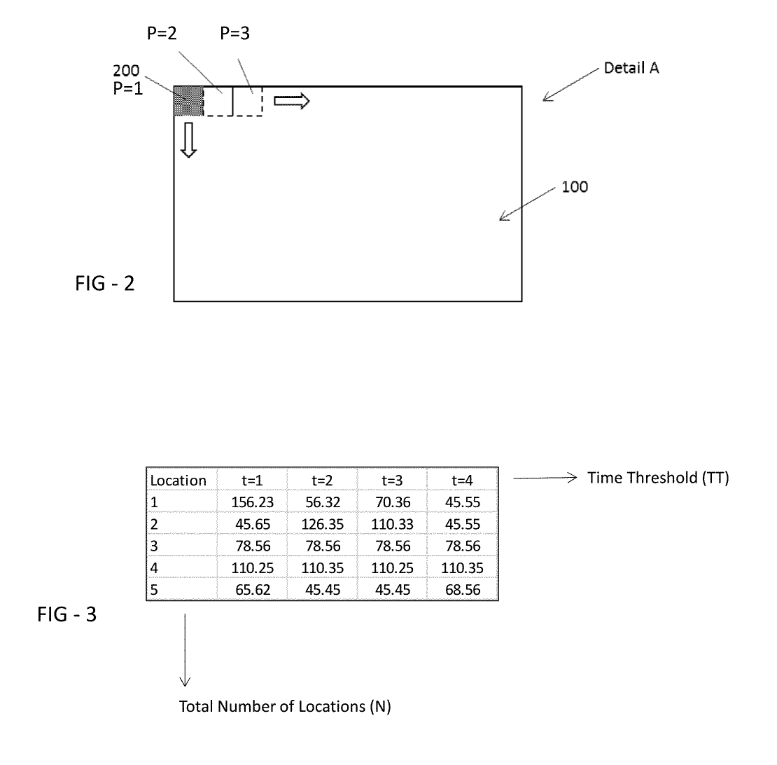

FIG. 2 is a detailed view of Detail A from FIG. 1, indicating an exemplary embodiment for the Analysis Area (AA) 200 as it travels through each Location(L) on the electronic display 100. The Analysis Area is generally a selection of pixels that will be analyzed together. While it is shown here as a block, rectangle, or otherwise four-sided polygon, any shape will work with the exemplary embodiments. The Analysis Area could be a small fraction of the total active display area of the electronic display, and while no fraction is necessary, it has been found that anything between 0.001% and 1% of the total active display area would produce an acceptable Analysis Area. In some embodiments, the AA can be as large as 5% of the total active display area. For an exemplary embodiment on a 3840×2160 UHD display, it has been found that an AA of a 64 pixel×64 pixel block works very well, but this is not required.

Generally speaking, the Analysis Area 200 begins at Location 1, performs a check sum calculation of the pixel data for each pixel within the Analysis Area 200 when located at Location 1, and then moves on to Location 2, and so on until the Total Number of Locations (N) has been calculated. While shown in FIG. 2 as beginning in the upper left hand corner of the display, moving horizontally across the top edge of the display, and then moving down to the next row, until reaching the bottom right corner of the display, this is not required. Any path for the Analysis Area will work for the disclosed embodiments as there is no particular path that is required. One could of course begin at any location, and travel across the display in any path that works for the particular embodiment.

FIG. 3 is a sample chart of exemplary check sum data for each Location(L) at each Time Interval(t). It should be noted that this is a small and simplified chart and does not necessarily correspond with the situation shown in FIG. 1. The check sum data can be calculated in a number of ways but would preferably be a sum of the bits of data sent to each pixel within the AA at each Location(L). Alternatively, it could be any other digital value applied to each pixel, or alternatively the actual voltages or power sent to each pixel. The values provided are simply to illustrate an embodiment of the invention, and do not have any particular form or units for each value. An exemplary embodiment functions more on the difference between the checksum totals, and not so much on what the underlying values are for calculating the checksum totals.

The Time Threshold (TT) may be referred to as the total amount of time that the checksum data is calculated, before the system begins to analyze said checksum data. This value can be selected based on a number of seconds, minutes, frames of video, or a cycle time based on how long it takes a processor to calculated each Location(L) across the entire display one time (i.e. TT=60 cycles, where the system calculates the check sum data for each location 60 times before analyzing the data). Referring again to an embodiment on a 3840×2160 UHD display, it has been found that the checksum data can be calculated for each Location(L) every 69 seconds (at a 30 Hz refresh rate). Here, the TT may be selected as X cycles, which could also be referred to as (X*69) seconds, i.e. 10 cycles could also be referred to as 690 seconds.

The resulting check sum data shown in FIG. 3 can be analyzed in a number of ways. Generally, a Pixel Delta (PΔ) may be calculated for the selection of check sum data which generally measures the amount of change that the pixels have gone through during the Time Threshold (TT). This amount of change in the pixel data across the TT can then be compared to a Pixel Threshold (PT), which can be used to identify the minimum amount of change in the pixel data across the TT before image retention becomes a concern. In short, when the system recognizes that a group of pixels has not seen a change in pixel data that exceeds the PT, image retention becomes a concern, and the Image Retention Prevention Method may be performed.

The Pixel Delta (PΔ) can be measured as the amount of variance across the check sum data. In some embodiments, this is calculated as the standard deviation of the check sum data. With this type of embodiment, the Pixel Threshold (PT) can be selected as the minimum level of standard deviation that is acceptable before image retention becomes a concern. This can vary widely depending on the system being used. For example, some systems may be so accurate that PT can be extremely small, or even near zero, so that image retention is not a concern unless the pixel data remains almost constant throughout the entire TT. In other systems, there may be noise in the system that would necessitate placing the PT at a higher level, such that pixel data would not have to be constant to trigger the concern over image retention, only that the amount of change was lower than a pre-selected amount (which can be well above zero).

For example, assume that PΔ is calculated as the standard deviation and PT is very low, for this example PT=0. When analyzing the data from FIG. 3, it is clear that Locations 1, 2, and 5 would not be low enough to be equal to or less than PT (PΔ(1)=50.44, PΔ(2)=42.50, and PΔ(5)=12.55). While Location 4 is very close, it is also not equal to or less than PT (PΔ(4)=0.06). However, Location 3 does appear to have a PΔ equal to or less than PT (PΔ(3)=0. Thus it can be observed, that setting PT very low or near zero will only catch groups of pixels that have seen almost no change whatsoever during the TT. One of skill in the art could therefore see that PT could be increased to a value higher than zero (if desired) to ensure that the system catches other groups of pixels which perhaps have changed slightly over the TT, but not enough to remove concerns about image retention. The user may select the appropriate PT for their particular application.

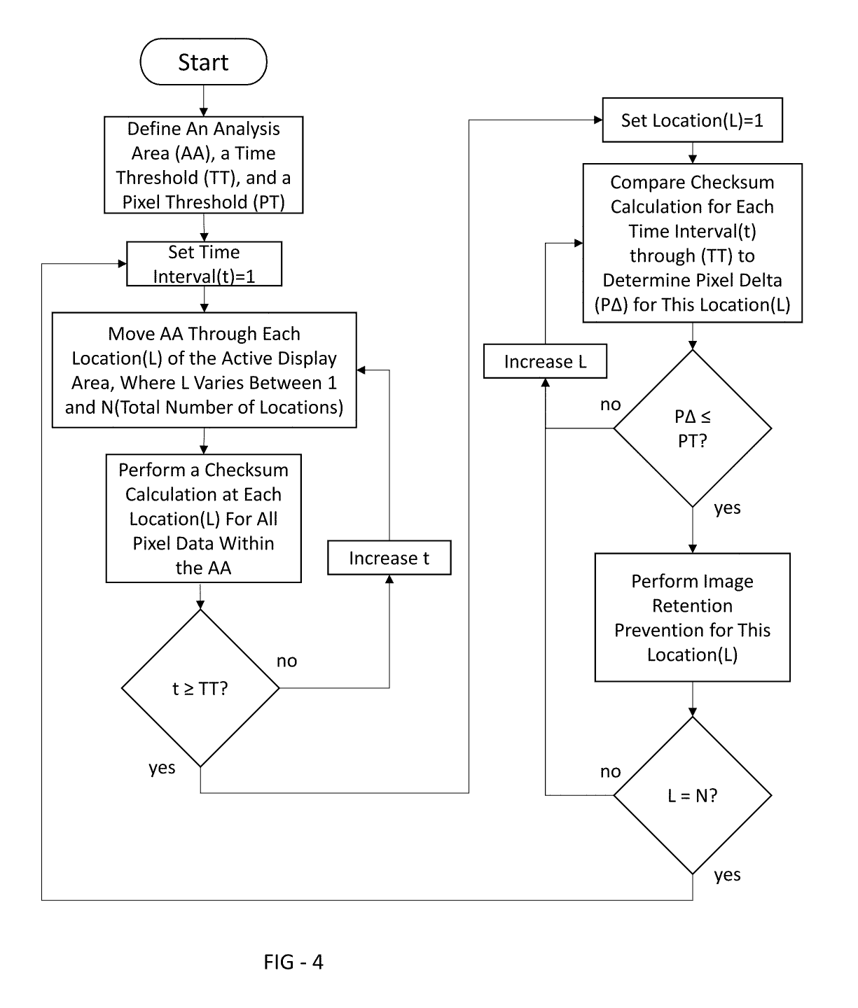

FIG. 4 is a logical flow chart for operating an exemplary form of the method. During the initial setup, the Analysis Area (AA), Time Threshold (TT), and Pixel Threshold (PT) should be defined. Next, the Time Interval should be reset, and while it is suggested to set t=1, embodiments could set t=0 as well. The system would then move the AA through each Location(L) of the active display area and perform the checksum calculation for all pixel data within the AA at each Location (L). If Time Interval(t) has reach TT, the system begins the analysis phase, if not, t is increased and this process is repeated again for each Location(L) on the active display area.

Once Time Interval(t) reaches TT, the Pixel Delta (PΔ) for the first Location(L=1) is calculated and compared to the PT. If PΔ is not less than or equal to PT, the system moves on to calculate PΔ for the next Location(L=2) and again compares PΔ to PT. When any PΔ is less than or equal to PT, an Image Retention Prevention Method is performed. Once each Position(P) has been analyzed, the system preferably returns to re-set the Time Interval(t) equal to 1 (or zero) and resumes calculating checksum data for each Location(L).

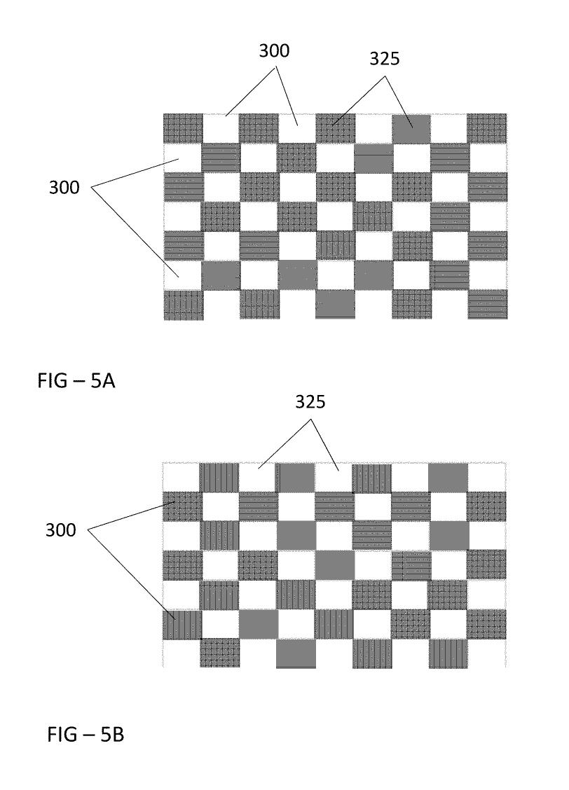

FIGS. 5A and 5B are front elevation views of a selection of pixels, where an embodiment of the Image Retention Prevention Method is being performed. Referring to FIG. 5A, odd numbered pixels are the modified pixels 325 while even numbered pixels are normal operation pixels 300. This pattern preferably continues across the entire AA (or the entire active image area of the display, as taught below) which has been determined to require the Image Retention Prevention Method. Referring to FIG. 5B, the previous pattern is preferably then switched so that even numbered pixels are the modified pixels 325 while odd numbered pixels are normal operation pixels 300.

An exemplary embodiment of the Image Retention Prevention Method would essentially transmit alternate pixel data (i.e. not the data which is necessary to create the image/video) to the modified pixels 325. While the modified pixels 325 are shown in FIGS. 5A-5B as 50% of the pixels in a selected area, this is not required. Alternatively, any selection of the pixels in the AA would be fine (ex. ⅓^{rd} of the pixels could be modified pixels 325 at any one time). In a first embodiment, the modified pixels 325 may be set to full on while the normal operation pixels 300 remain under normal operation. In a second embodiment, the modified pixels may be set to full off while the normal operation pixels 300 remain under normal operation. In a third embodiment, the modified pixels 325 may be set to full on while the normal operation pixels 300 are no longer performing a normal operation (i.e. whatever is required for the image/video) but are now set to full off. In a fourth embodiment, the modified pixels 325 may be set to full off while the normal operation pixels 300 are set to full on. In a fifth embodiment, both the modified 325 and normal operation pixels 300 are provided with the data to create the required image/video but the voltages/power for the modified pixels 325 is reduced by some factor (ex. by half, by a third, or by a small percentage) while the remaining normal operation pixels 300 continue to receive the required voltage/power to generate the image/video. In each of the embodiments, the even/odd pixels of the display preferably cycle back and forth as indicated in FIGS. 5A and 5B. When using an LED backlit LCD for the electronic display 100, it may be desirable to increase the backlight when performing the Image Retention Prevention Method, since reducing the luminance of the pixel could result in a loss of luminance of the display. In an exemplary embodiment with a direct lit dynamic dimming LED backlight, only the region of the backlight that is behind the AA being addressed would be increased in luminance, as opposed to the entire backlight. In embodiments that use other types of electronic displays, increasing the luminance of the electronic display itself (if no backlight is used) would be preferred while performing the Image Retention Prevention Method.

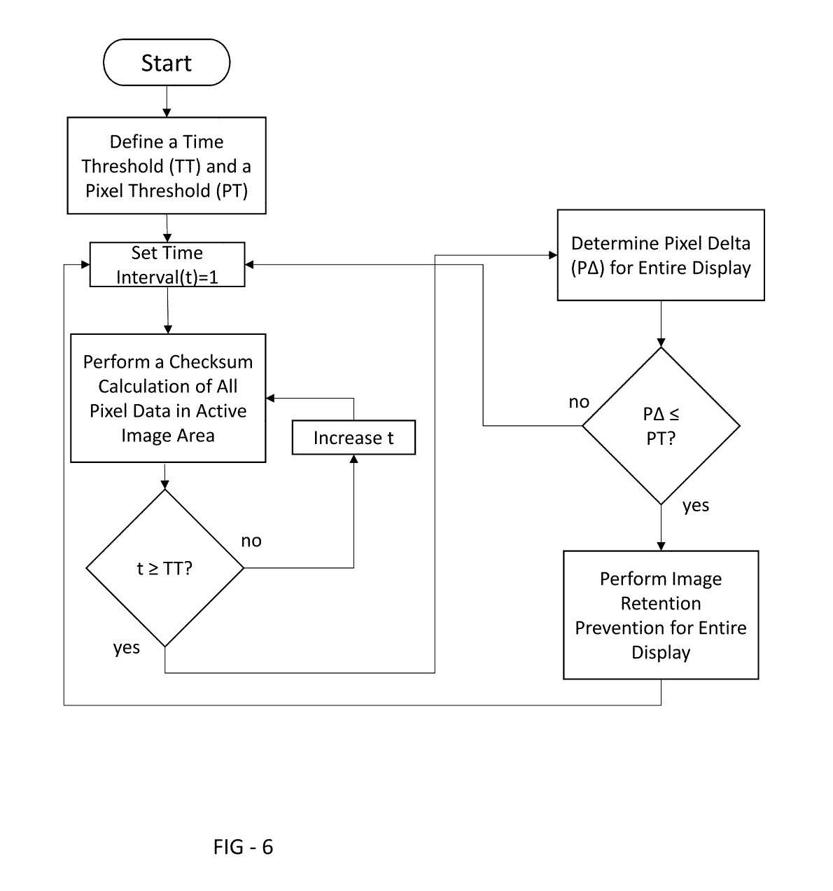

FIG. 6 is a logical flow chart for a simplified embodiment where the entire active image display area is used as the AA. This method may be appropriate for determining whether an entire display has frozen or malfunctioned so that a static image remains on the entire display for an extended period of time. Here, a checksum is performed for the pixel data across all of the pixels on the electronic display, rather than only within a designated AA that is moved across the entire display. Once checksums have been calculated for the entire Time Interval(t), PΔ is calculated for the entire display and compared to a PT for the entire display. If very little change in the pixel data is calculated, then image retention may be a concern, and the Image Retention Prevention Method should be ran for the entire display. The concept would be similar to that described above, except rather than performing the method over one or more AAs having an unacceptable PΔ, the method is ran across the entire display.

As noted above, in the exemplary embodiments the overall appearance of the display should not be affected when the Image Retention Prevention Method is performed. In other words, to a viewer, there should be no discernable difference in the viewed image whether the Image Retention Prevention Method is being ran or not.

Having shown and described a preferred embodiment of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

We claim:

1. A method for preventing image retention in an electronic display comprising the steps of:
defining an analysis area (AA), a time threshold (TT), and a pixel threshold (PT);
transmitting pixel data to the electronic display;
moving the AA through every location of an active display area of the electronic display;
performing a checksum calculation of the pixel data within each location for an interval of time until reaching TT;
comparing the checksum calculation for each location across each interval of time to determine if the change in pixel data is less than PT for each location; and
performing an image retention prevention method for any location where the change in pixel data is less than PT.

2. The method of claim 1 wherein:
the analysis area is a four-sided polygon.

3. The method of claim 1 wherein:
the analysis area is less than 5% of the active display area.

4. The method of claim 1 wherein:
the analysis area is less than 1% of the active display area.

5. The method of claim 1 wherein:
the step of comparing the checksum calculation for each location across each time interval comprises calculating the standard deviation for each location across each time interval.

6. The method of claim 1 wherein:
PT is between zero and one.

7. The method of claim 1 wherein:
the step of performing the checksum calculation is a summation of the bits of data sent to each pixel within the AA at each Location.

8. The method of claim 1 wherein:
PT is the minimum level of standard deviation that is acceptable before image retention becomes a concern.

9. A method for preventing image retention in an electronic display comprising the steps of:
defining a time threshold (TT) and a pixel threshold (PT);
transmitting pixel data to the electronic display;
performing a checksum calculation of all pixel data within an active image area of the electronic display for an interval of time until reaching TT;
comparing the checksum calculation for each interval of time to determine if the change in pixel data is less than PT; and
performing an image retention prevention method for the active image area if the change in pixel data is less than PT.

10. The method of claim 9 wherein:
the step of comparing the checksum calculation for each interval of time comprises calculating the standard deviation across each time interval.

11. The method of claim 9 wherein:
PT is less than one.

12. The method of claim 9 wherein:
the step of performing the checksum calculation is a summation of the bits of data sent to each pixel within the active image area.

13. The method of claim 9 wherein:
PT is the minimum level of standard deviation that is acceptable before image retention becomes a concern.

14. The method of claim 9 wherein:
the step of performing the image retention algorithm is performed by transmitting alternate pixel data to a portion of the pixels in the active image area.

15. The method of claim 14 wherein:
the alternate pixel data turns the pixel to either full on or full off.

16. The method of claim 9 wherein:
the image retention algorithm is performed without producing a noticeable difference in a displayed image to a viewer of the electronic display.

17. The method of claim 9 further comprising the step of:
increasing luminance of the electronic display while performing the image retention prevention method.

18. An electronic display assembly comprising:
an electronic display;
a display controller in electrical connection with the electronic display;
a processor within the display controller which
accepts a time threshold (TT) and a pixel threshold (PT);
transits pixel data to the electronic display;
performs a checksum calculation of all pixel data within an active image area of the electronic display for an interval of time until reaching TT;
compares the checksum calculation for each interval of time to determine if the change in pixel data is less than PT; and
performs an image retention prevention method for the active image area if the change in pixel data is less than PT.

19. The electronic display assembly of claim 18 wherein:
the processor performs the image retention algorithm by transmitting alternate pixel data to a portion of the pixels in the active image area.

20. The electronic display assembly of claim 18 wherein:
the processor increases luminance of the electronic display while performing the image retention prevention method.
